(19) United States
(12) Patent Application Publication
(10) Pub. No.: US 2026/0036813 A1
(43) Pub. Date: Feb. 5, 2026

(54) IN-PLANE MIRROR FOLDED LIGHT-GUIDE

(71) Applicant: LUMUS LTD., NESS ZIONA (IL)

(72) Inventors: Yochay DANZIGER, Kfar Vradim (IL); Eitan RONEN, NESS ZIONA (IL)

(73) Assignee: LUMUS LTD., NESS ZIONA (IL)

(21) Appl. No.: 19/099,208

(22) PCT Filed: Jul. 28, 2023
(86) PCT No.: PCT/IB2023/057688

§ 371 Date: Jan. 28, 2025

Related U.S. Application Data
(60) Provisional application No. 63/393,928, filed on Jul. 31, 2022.
(60) Provisional application No. 63/453,327, filed on Mar. 20, 2023.

(51) Int. Cl. G02B 27/01

(52) U.S. Cl. CPC G02B 27/0172; G02B 2027/0123

(57) ABSTRACT

According to an example, an optical device may include a light-guide optical element having a front surface and a rear surface that are parallel to each other, a reflector configured to receive a plurality of guided image beams and reflect a plurality of reflected guided image beams, the plurality of guided image beams and plurality of reflected guided image beam being propagated within the light-guide optical element between the front surface and the rear surface; a first aperture expander having a first plurality of partially reflecting parallel facets configured to expand the plurality of reflected guided image beams and provide a first plurality of expanded image beams; and a second aperture expander having a second plurality of partially reflecting parallel facets configured to expand the first plurality of expanded image beams and provide a second plurality of expanded image beams configured to exit from the rear surface.

### CROSS-REFERENCE TO RELATED APPLICATIONS

This application is based upon and claims the benefit of priority under 35 USC 119(e) of U.S. Patent Application No. 63/393,928 filed on Jul. 31, 2022, titled In-plane Mirror Folded Lightguide, the entire disclosure of which is incorporated herein by reference in its entirety. This application is also based upon and claims the benefit of priority under 35 USC 119(e) of U.S. Patent Application No. 63/453,327 filed on Mar. 20, 2023, also titled In-plane Mirror Folded Lightguide, the entire disclosure of which is incorporated herein by reference in its entirety.

### BACKGROUND

Unless otherwise indicated herein, the materials described in this section are not prior art to the claims in this application and are not admitted to be prior art by inclusion in this section. The present disclosure relates in general to systems and methods of presenting information to a user, more particularly, to optical systems and near eye displays for presenting information to a user.

Wearable optical devices, such as near eye displays or smart glasses, are often cumbersome to wear, thus limiting their comfort and utility. Further, some wearable optical devices have a limited ability to view surrounding scenery or do not have a wide viewing angle because of obstructions in the view field due to the presence of various optical components. Finally, awkward placement of an image projector may require the location of an image injection point be placed at a location that is relatively far from an image output coupling region leading to degradation of image quality due to longer image paths. What is needed is a solution that addresses these issues, and others.

### SUMMARY

According to an example, an optical device is generally described. The optical device may include a light-guide optical element having a front surface and a rear surface that are parallel to each other; a reflector configured to receive a plurality of guided image beams and reflect a plurality of reflected guided image beams, the plurality of guided image beams and plurality of reflected guided image beam being propagated within the light-guide optical element between the front surface and the rear surface; a first aperture expander having a first plurality of partially reflecting parallel facets configured to expand the plurality of reflected guided image beams and provide a first plurality of expanded image beams; and a second aperture expander having a second plurality of partially reflecting parallel facets configured to expand the first plurality of expanded image beams and provide a second plurality of expanded image beams.

According to this example, the optical device wherein the plurality of guided image beams may have a guided image beam central axis, wherein the plurality of reflected guided image beams may have a reflected guided image beam central axis, and wherein an angle between the guided image beam central axis and the reflected guided image beam central axis may be greater than 90°. The optical device wherein the reflector may be at least one of: disposed perpendicular to the front surface; and disposed on a peripheral edge of light-guide optical element, the reflector may be configured to fully reflect the received plurality of guided image beams. The optical device may further include an input coupler configured to receive a collimated first image beam from an image projector and output the plurality of guided image beams, the plurality of guided image beams being propagated within the light-guide optical element between the front surface and the rear surface, wherein the input coupler may be disposed one of adjacent to one of the front surface and the rear surface and at least partially embedded within the light-guide optical element, and wherein the input coupler is one of a prism, a diffractive element, a reflective element, or a holographic element.

According to this example, the optical device wherein the reflector may be a mirror facing an interior portion of the light-guide optical element and disposed adjacent to a peripheral edge of the light-guide optical element in a location that is one of: vertically below the input coupler, and vertically above the input coupler. The optical device wherein the first plurality of partially reflecting parallel facets may be inclined at a first angle that is one of oblique relative to at least one of the front surface and a transverse plane perpendicular to the front surface; and wherein the second plurality of partially reflecting parallel facets are inclined at a second angle that is one of oblique relative to at least one of the front surface and a transverse plane perpendicular to the front surface. The optical device wherein at least one of the first plurality of partially reflecting parallel facets and the second plurality of partially reflecting parallel facets may include an angularly selective coating.

According to this example, the optical device wherein an upper portion of the light-guide optical element may include an optically clear line-of-sight region, and wherein the second aperture expander may be disposed vertically below the line-of-sight region. The optical device wherein the first aperture expander may be configured to expand the plurality of reflected guided image beams in a first dimension, the second aperture expander may be configured to expand the first plurality of expanded image beams in a second dimension, and the first dimension and the second dimension may be substantially orthogonal to each other. The optical device may further include a light cover disposed on a portion the front surface adjacent to the reflector, the light cover may be configured to at least one of: reduce scattering of the plurality of guided image beams, and reduce impingement of environmental light upon the reflector. The optical device wherein the second plurality of expanded image beams are configured to exit from the rear surface.

According to an example, an optical system is generally described. The optical system may include a light-guide optical element having a front surface and a rear surface are parallel to each other; an image projector may be configured to produce a collimated first image beam based on a digital image, wherein the collimated first image beam is collimated to infinity; an input coupler configured to receive the collimated first image beam and output a plurality of guided image beams within the light-guide optical element, the plurality of guided image beams being propagated between the front surface and the rear surface; a reflector configured to receive a plurality of guided image beams and reflect a plurality of reflected guided image beams, the plurality of guided image beams being propagated within the light-guide optical element between the front surface and the rear surface; a first aperture expander having a first plurality of partially reflecting parallel facets configured to expand the plurality of reflected image beams in a first dimension and provide a first plurality of expanded image beams; and a second aperture expander having a second plurality of partially reflecting parallel facets configured to expand the first plurality of expanded image beams in a second dimension and provide a second plurality of expanded image beams configured to exit from the rear surface.

According to this example, the optical system wherein the input coupler may be disposed one of adjacent to one of the front surface and the rear surface and at least partially embedded within the light-guide optical element, and wherein the input coupler may be one of a prism, a diffractive element, a reflective element, or a holographic element. The optical system may further include a frame configured to support at least a portion of the light-guide optical element and image projector, the frame being configured to be worn on a portion of a head of a user adjacent to an eye of the user; an optical engine configured to receive the digital image and operate the image projector; and a controller configured to operate the optical engine and projector. The optical system wherein the plurality of guided image beams may have a guided image beam central axis, wherein the plurality of reflected guided image beams may have a reflected guided image beam central axis, and wherein an angle between the guided image beam central axis and the reflected guided image beam central axis may be greater than 90°.

According to this example, the optical system wherein the reflector may be a mirror facing an interior portion of the light-guide optical element and disposed adjacent to a peripheral edge of the light-guide optical element that may be one of: vertically below the input coupler, and vertically above the input coupler, the reflector may be configured to fully reflect the received plurality of guided image beams. The optical system wherein the first aperture expander may include a plurality of partially reflecting parallel facets that are inclined at an angle that is one of: oblique relative to at least one of the front surface and a transverse plane perpendicular to the front surface, and perpendicular to the front surface. The optical system wherein at least one of the first plurality of partially reflecting parallel facets and the second plurality of partially reflecting parallel facets may include an angularly selective coating. The optical system wherein an upper portion of the light-guide optical element may include an optically clear line-of-sight region, and wherein the second aperture expander may be disposed vertically below the line-of-sight region. The optical system may further include a partial plane reflector disposed within the light-guide optical element parallel with the front surface; and a light cover may be disposed on a portion the front surface adjacent to the reflector, the light cover may be configured to at least one of: reduce scattering of the plurality of guided image beams, and reduce impingement of environmental light upon the reflector.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 illustrates a block diagram of an optical system, in accordance with various examples of the present disclosure.

FIG. 2A illustrates a front plan view of an optical device including a light-guide optical element (LOE), in accordance with various examples of the present disclosure.

FIG. 2B illustrates a side plan view of the optical device of FIG. 2A, in accordance with various examples of the present disclosure.

FIG. 3A illustrates a front plan view of an optical system including a light-guide optical element, in accordance with various examples of the present disclosure.

FIG. 3B illustrates a side plan view of the optical system of FIG. 3A, in accordance with various examples of the present disclosure.

FIG. 4 illustrates a schematic isometric view of a portion of an aperture expander with partially reflecting parallel facets, in accordance with various examples of the present disclosure.

FIG. 5 illustrates a front plan view of an optical device including a light-guide optical element, in accordance with various examples of the present disclosure.

FIG. 6 illustrates a front plan view of an optical device including a light-guide optical element, in accordance with various examples of the present disclosure.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

To be described in more detail below, a wearable device, such as a near eye display and/or smart glasses, can be implemented by a system and method described in accordance with the present disclosure. The system can efficiently provide high quality optical information to a user in various applications.

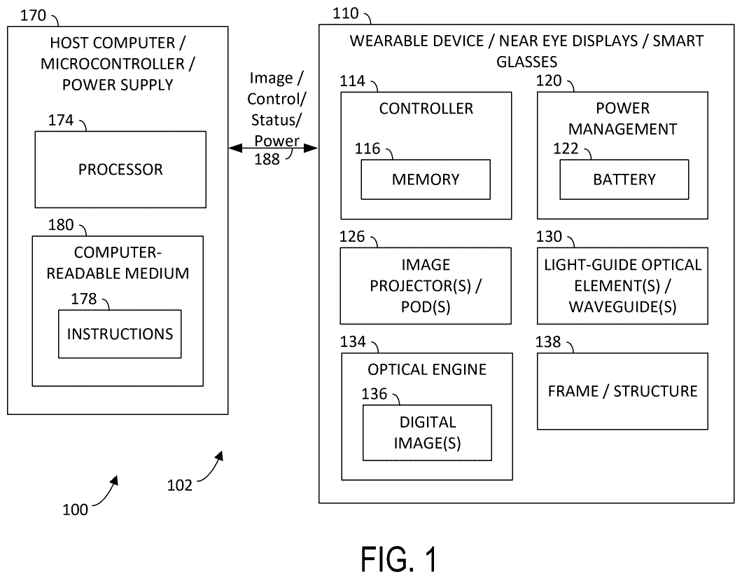

FIG. 1 illustrates a block diagram of an optical system, in accordance with various examples of the present disclosure. Optical system 100 may include two or more devices or components. Optical system 100 may be implemented generally as a hybrid system including various electronic, optical, and electro-optical elements. An optical device 102 may include one or more elements from optical system 100. To be described in more detail below, an optical system 100 may include a wearable device 110, such as one or more near eye displays or smart glasses, which may be worn on or about the head of a user to convey optical information to one or more eyes of a user.

Wearable device 110 may include a controller 114 with a memory 116 where controller 114 may be configured to send and receive electrical signals to various other elements in optical system 100, to execute program instructions stored in memory 116 in order to process and provide information, to operate wearable device 110, and to interact with other systems outside wearable device 110, for example. Controller 114 may include a microcontroller, a processor, various discrete components, programmable logic devices, and/or various interface circuits that may access memory 116 which may be removable, replaceable, programmable, and reprogrammable to update instructions to controller 114.

Wearable device 110 may also include a power management module 120 having a battery 122, where power management module 120 may be configured to charge, discharge, and monitor power usage for battery 122. Various elements of wearable device 110 may receive power from battery 122, including controller 114, one or more image projector(s) 126 (e.g., a projecting optical device, or POD), and optical engine 134 having one or more digital images 136, for example.

Wearable device 110 may also include one or more image projectors 126, each configured to produce a collimated image beam based on a digital image 136. The collimated image beam may be an illuminated representation of the digital image having an image field which is a two-dimensional representation of the digital image based on either a single graphical image (e.g., a static image) or a sequence of graphical images (e.g., a moving image). The collimated image beam may be collimated to infinity.

Wearable device 110 may also include one or more light-guide optical elements 130 (e.g., LOEs, also denoted as waveguides WGs) comprising transparent materials configured to receive and propagate light, where light may enter into and exit from various external and internal surfaces of light-guide optical element 130. For example, the transparent material comprising light-guide optical element 130 may include optical glass or other suitable material that is transformed into complex optical structures using a process that may include coating, stacking, slicing, polishing, and shaping the transparent materials. The process may include the addition of partially reflective or fully reflective materials such as mirror coatings, for example. Similarly, the process may also include the addition of partially opaque or fully opaque materials such as light covers to block light, for example.

Wearable device 110 may also include one or more optical engines 134 coupled to the one or more image projectors 126 and light-guide optical elements 130. Optical engine 134 may be configured to directly operate image projector 126 under the direction of the controller 114. For example, optical engine 134 may provide graphics processing for the digital image before projection of an illuminated representation of the digital image by image projector 126.

Wearable device 110 may also include a frame 138 (e.g., a structure) for supporting and retaining one or more elements in wearable device 110. For example, frame 138 may support and retain a first image projector 126 in position next to a first light-guide optical element 130. Similarly, frame 138 may support and retain a second image projector 126 in position next to a second light-guide optical element 130. In this manner, frame 138 may support and retain one or two image projector 126 and light-guide optical element 130 pairs on or about the head of a user. References are made herein regarding the orientation of various elements relative to each other. such references may also include reference to various elements of wearable device 110 when supported by frame 138 or in reference to a three-dimensional (3D) reference (e.g., X, Y, Z axes), as described in the relevant drawing figure.

Optical system 100 may also include a host computer 170 that may include a processor 174 configured to read and execute operations based on instructions 178 stored in a computer-readable medium 180. Instructions 178 may include at least some instructions provided to controller 114 and stored in memory 116. Host computer 170 may communicate with one or more elements of wearable device 110 over a signal and power bus 188. In this manner, host computer 170 may provide power to charge battery 122, provide instructions to and receive status from controller 114 and various other elements of wearable device 110, and to provide digital image data to optical engine 134.

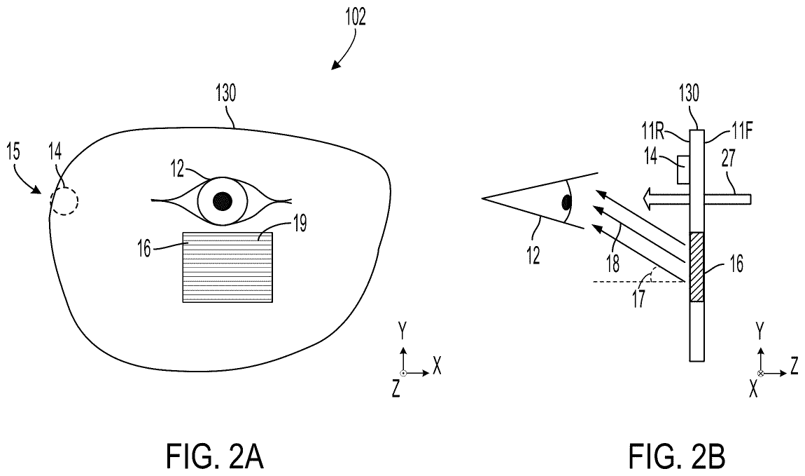

FIG. 2A illustrates a front plan view of an optical device including a light-guide optical element (LOE), in accordance with various examples of the present disclosure. Optical device 102 may include light-guide optical element 130 having an aperture expander 16 disposed at least partially within light-guide optical element 130. As will be explained more fully below, aperture expander 16 may include a plurality of partially reflecting parallel facets 19 (e.g., internal planar surfaces) configured to receive a plurality of light beams from a first direction and expand the beam width or the aperture of the light received light beams in a second direction that may be different from and may also be substantially orthogonal to the first direction. In this manner, aperture expander 16 may be configured to expand the received beams in the two dimensions.

The term facet may generally refer to a reflective optical structure with a flat surface. Each facet may include an angularly selective coating which may have an optical axis that deviates from a normal angle to the coating so as to selectively pass or attenuate illumination having the same or a different orientation, respectively. As used herein, an aperture expander may include a plurality of planar, mutually-parallel and partially reflecting optical elements (e.g., facets) spaced apart from each other and which may be included at an angle that may be oblique relative to at least one major external surface of light-guide optical element 130, for example. Hence, each of the facets 19 in aperture expander 16 may be parallel to each other and disposed at the same oblique angle. Also, the facets described herein may include an angularly selective coating and may be controlled to have multiple states (e.g., on/off) or to change a level of reflectivity and/or transmissivity of each facet or a cooperative collection of facets in a structure. A final facet (e.g., a terminal facet) in a structure may be fully mirrored (e.g., not partially mirrored) to reflect any remaining illumination that may have passed through the prior facets in the structure. Alternatively, each facet may have the same partial reflectivity for consistency, reduced complexity, and simpler construction.

As used herein, the term substantially refers generally to a tolerance of less than one degree, where substantially orthogonal may refer to two lines or two planes that cross at an angle that may visually compare with about 90° but could vary between less than 89.5° and 90.5°, for example. Similarly, substantially vertical may refer to an angle with a vertical plane at about 90° that could vary between less than 89.5° and 90.5° from that vertical plane, for example. Finally, substantially horizontal (e.g., or substantially lateral) may refer to an angle with a horizontal plane at 0° but could vary between less than +0.5° and −0.5° from that horizontal plane, for example. In this manner, perpendicularity may be very accurate and may typically refer to a variation that is much less than 1° (e.g., <<1°) on the order of less than 0.1°, 0.05°, or 0.01° in some examples.

Light-guide optical element 130 may also include an input coupler 14 located at a position 15 which may be on, near, or embedded within a peripheral edge of light-guide optical element 130. Input coupler 14 may be an optical element configured to conduct image illumination into optical element 130. Alternatively, input coupler 14 may be located at any suitable position capable of performing as described herein. Thus, the location of input coupler 14 at position 15, as illustrated in FIG. 2B, is not considered limiting. As will be described more fully below, input coupler 14 may be located at a position on, near, or embedded within a portion of light-guide optical element 130 and may be configured to couple light from image projector 126 into light-guide optical element 130. In order to obtain optimal beam propagation, it may be preferable that the injection angle of the input image beam from image projector 126 may be shallow to promote total internal reflection (TIR) so that the beams may propagate with minimal escape while remaining within light-guide optical element 130 (e.g., to reduce scatter). Input coupler 14 may be a prism, a diffractive element, reflective element, or a holographic element. When input coupler 14 is a prism, input coupler 14 may be rotated so that image projector 126 may mounted adjacent to light-guide optical element 130 in a manner that is less obtrusive to a user. As shown in FIG. 2A, 2B, and similar to other drawings, it may be helpful to refer to a three-dimensional (3D) framework of orthogonal axes, X, Y, and Z, where X corresponds generally to a horizontal or lateral direction (e.g., left-right), Y corresponds generally to a vertical direction (e.g., above-below, or up-down), and Z corresponds to a direction into and out of (e.g., front-back, or into and out from) the plane of FIG. 2A.

FIG. 2B illustrates a side plan view of the optical device of FIG. 2A, in accordance with various examples of the present disclosure. Light-guide optical element 130 may include a front surface 11F and a rear surface 11R which may be parallel to each other, and where environmental illumination, from scenery for example, principally may enter light-guide optical element 130 at front surface 11F and exit light-guide optical element 130 at rear surface 11R. Aperture expander 16 may be disposed on, adjacent to, near, or embedded within light-guide optical element 130 in a position vertically below the customary location of an eye 12 of a user when using wearable device 110, for example. In this manner, environmental light may enter light-guide optical element 130 along an optically clear line-of-sight 27 region in a manner that the incoming light is directed at an eye 12 of a user. Optically clear, as used herein, refers to being clear of reflecting or deflecting optical structures so that environmental light may pass in an unperturbed manner through a portion of light-guide optical element 130 and provide the user an unobstructed view of their environment through the optical structure, for example.

As mentioned above, aperture expander 16 may include a plurality of partially reflecting parallel facets 19 configured to receive a plurality of light beams from a first guided direction and expand the received light beams in a second output coupled direction 18. The expanded light beams 18 from aperture expander 16 may exit the rear surface 11R at an exit angle 17 directed (e.g., guided to unguided) to an eye 12 of a user, for example. Alternatively, a center (e.g., a vertical mid-point) of aperture expander may be disposed below line-of-sight 27 region while at least some of aperture expander 16 may extend into line-of-sight 27 region depending on exit angle 17 and possibly other factors, for example. In this manner, an upper portion of the light-guide optical element may include an optically clear line-of-sight region 27, where the upper portion includes a vertically separated portion above a mid-point of aperture expander 16, for example.

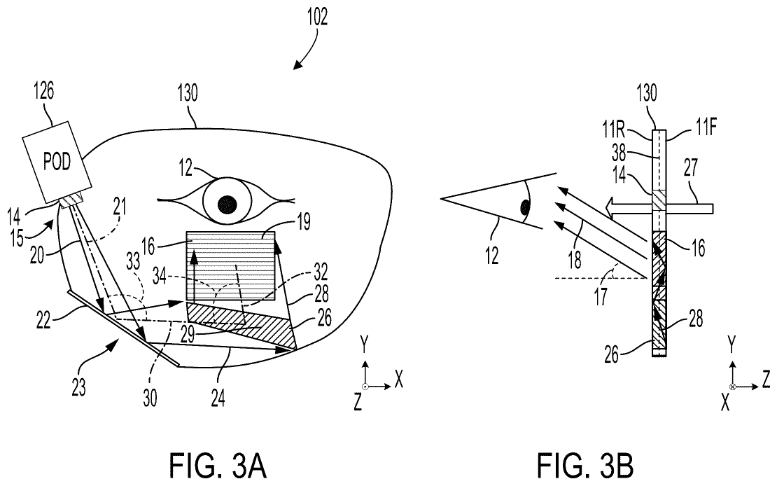

FIG. 3A illustrates a front plan view of an optical system including a light-guide optical element, in accordance with various examples of the present disclosure. Optical device 102 may include light-guide optical element 130 configured to receive a collimated first image beam from image projector 126 where a first image beam is supplied (e.g., injected directly) into an input portion of input coupler 14 and coupled at a shallow angle to enter light-guide optical element 130. In practice, the distance between image projector 126 and input coupler 14 may be very short. The injected image beams may be collimated for every point in the image, where different points in the image are diverging as they are generated by image projector 126. Collimated image beam from image projector 126 may be injected within a portion of light-guide optical element 130 to produce a plurality of guided image beams 20 that are propagated and reflected due to total internal reflection (TIR) within light-guide optical element 130 between the front surface 11F and the parallel rear surface 11R. For simplicity, the plurality of guided image beams 20 may correspond with a plurality of different points in an image field of collimated first image beam and may have a guided image beam central axis 21 corresponding to a central ray within the plurality of guided image beams 20.

The plurality of guided image beams 20 may continue to expand within light-guide optical element 130 and be directed to a reflector 22 that may be disposed at a second location 23 which may be on or near a peripheral edge of light-guide optical element 130. Alternatively, reflector 22 may be located within a portion of light-guide optical element 130 away from a peripheral edge. Reflector 22 may include a mirror facing an interior portion of light-guide optical element 130 and may be located in a position vertically below input coupler 14 as illustrated, for example. Reflector 22 may be formed as a mirrored surface configured to fully reflect the plurality of guided image beams 20. In this manner, reflector 22 may be configured to substantially reflect all of the impinging image beams in the plurality of guided image beams 20. Stated differently, reflector 22 may be substantially non-transmissive for the plurality of guided image beams 20. For example, reflector 22 may include a coating configured to be transmissive of scenery light (e.g., light at different angles) but reflective of the guided image beams 20 that arrive at reflector 22 within expected angles. Reflector 22 may be disposed perpendicular to front surface 11F and the rear surface 11R, which are parallel. Hence, any angular reference to front surface 11F may equivalently be referred to rear surface 11R. Alternatively, reflector 22 may be disposed at an angle to the front surface 11F.

The plurality of guided image beams 20 may be reflected by reflector 22 as a plurality of reflected guided image beams 24 having a reflected guided image beam central axis 30 that may correspond to a central ray of the plurality of reflected guided image beams 24 as they leave the surface of reflector 22. In this manner, a first beam angle 33 may be formed between guided image beam central axis 21 and reflected guided image beam central axis 30, where first beam angle 33 may be greater than 90°. When first beam angle 33 between the beam central axis 21 and reflected beam 30 central axis is greater than 90°, the plurality of guided image beams 20 and the plurality of reflected guided image beams 24 may provide an improved separation by routing around other optical elements in light-guide optical element 130, allowing other optical elements to be larger as well as having improved light gathering capability as compared with a conventional light-guide optical element. Alternatively, first beam angle 33 may be less than or equal to 90°. Here and elsewhere in this disclosure, reflection of the plurality of guided image beams 20 by reflector 22 to produce the plurality of reflected guided image beams 24 and continued guidance of the reflected image beams by total internal reflection (TIR) within light-guide optical element 130 may be considered a type of in-plane folding of the plurality of guided image beams 20. Guided image beam central axis 21, reflected guided image beam central axis 30, and an intersection of guided image beam central axis 21 and reflected guided image beam central axis 30 (e.g., two lines and a point of intersection) may form a plane about which the image beams are folded. After leaving reflector 22, the plurality of reflected guided image beams 24 may be directed to a first aperture expander 26 that may be disposed at least partially within light-guide optical element 130.

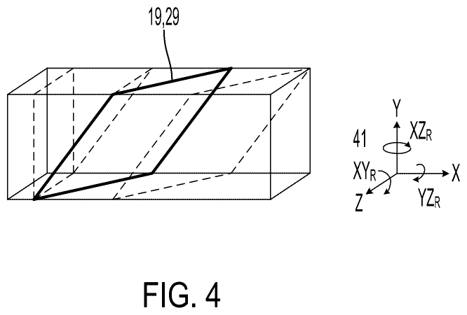

First aperture expander 26 may include a first plurality of partially reflecting parallel facets 29 (e.g., surfaces or reflectors) that may be configured to receive the plurality of reflected guided image beams 24 and expand the plurality of reflected guided image beams 24 in a first dimension to produce a first plurality of expanded image beams 28 having an expanded image guided beam central axis 32 that may correspond to a central ray of the plurality of expanded image beams 28 as they leave the first aperture expander 26 (e.g., guided to guided). In this manner, a second beam angle 34 may be formed between reflected beam central axis 30 and first expanded beam central axis 32 where second beam angle 34 may be less than 90°. It is noted that the plurality of partially reflecting parallel facets 29 may be different from reflector 22 which may be configured to substantially reflect all of the impinging image beams in the plurality of guided image beams 20. The first plurality of partially reflecting parallel facets 29 may be inclined at an angle that may be oblique relative to at least one of the parallel front surface 11F and a transverse plane (e.g., an X-Z plane) perpendicular to front surface 11F, or oblique to both for example. In this manner, the term oblique applied to a plurality of partially reflecting parallel facets may be used in reference to major external surfaces, such as front surface 11F and parallel rear surface 11R, which may align with orthogonal X, Y, Z axes and which may be at right angles to each other, as illustrated. This oblique aspect will be further described briefly in reference to FIG. 4. In this manner, first plurality of expanded image beams 28 may achieve larger and more uniform illumination. Alternatively, first aperture expander 26 may have a plurality of partially reflecting parallel facets 29 that are disposed perpendicular to front surface 11F. A coating on the plurality of parallel facets in first aperture expander 26 may reflect light most efficiently at predetermined angles. According to an example, when second beam angle 34 is large (e.g., close to 90°) this may enable production and use of an optimal coating for the plurality of parallel facets 29 in first aperture expander 26, especially in the situation where the plurality of parallel facets 29 are inclined at an oblique angle and not perpendicular to front surface 11F, for example. This may be due to the angular spectrum of the reflected beams being substantially separated from the angular spectrum of the transmitted beams. Further, this may enable use of polarization insensitive coatings where the Brewster angle may be outside the reflective angular spectrum, which may result in a performance improvement.

After leaving first aperture expander 26, the first plurality of expanded image beams 28 may be directed to a second aperture expander 16, mentioned briefly above. Second aperture expander 16 may be disposed at least partially within light-guide optical element 130. Aperture expander 16 may include a second plurality of partially reflecting parallel facets 19 configured to receive first plurality of expanded image beams 28 from first aperture expander 26 in a first direction and expand the expanded image beams 28 in a second direction that may be substantially orthogonal to the first direction.

As described, first aperture expander 26 may expand reflected guided image beams 24 in a first dimension (e.g., in a substantially lateral or X-axis direction) as a first plurality of expanded image beams 28, and subsequently second aperture expander 16 expands the first plurality of expanded image beams 28 in a second dimension (e.g., in a substantially vertical or Y-axis direction) as a second plurality of expanded image beams 18 which may exit from rear surface 11R toward an eye 12 of a user, for example. In this manner, first aperture expander 26 and second aperture expander 16 may cooperate to expand a version of input beam in two dimensions (2D), thus resulting in a two-dimensional (2D) expansion of the original aperture of image projector 126.

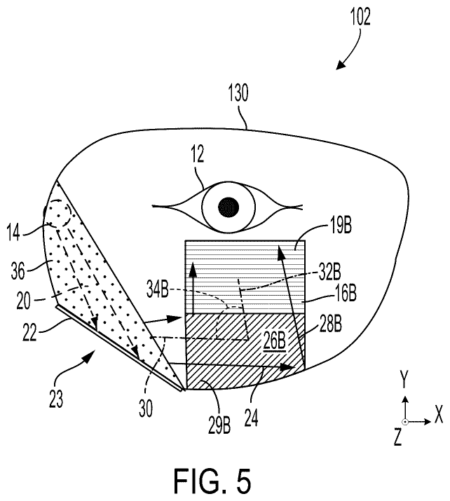

The planar shape of first aperture expander 26 corresponds to a minimum size cross section capable of suitably expanding reflected guided image beams 24 into the first plurality of expanded image beams, where first aperture expander 26 may merely touch an adjacent edge of light-guide optical element 130 at one point (e.g., compare with FIG. 5). An advantage of this minimum size first aperture expander 26 may include minimizing loss of reflecting beams in a less beneficial direction, thereby improving total waveguide efficiency.

FIG. 3B illustrates a side plan view of the optical device of FIG. 3A, in accordance with various examples of the present disclosure. FIG. 3B illustrates total internal reflection (TIR) of the first plurality of expanded image beams 28 within light-guide optical element 130 after leaving first aperture expander 26. In each of the disclosed examples, a partial plane reflector 38 may be introduced in light-guide optical element 130 disposed between front surface 11F and rear surface 11R to provide better light mixing and generate more uniform illumination.

FIG. 4 illustrates a schematic isometric view of a portion of an aperture expander with partially reflecting parallel facets, in accordance with various examples of the present disclosure. As described above, first aperture expander 26 may include a plurality of partially reflecting parallel facets 29 and second aperture expander 16 may include a second plurality of partially reflecting parallel facets 19 that may be inclined at an angle that may be oblique relative to at least one of front surface 11F and a transverse plane (e.g., an X-Z plane) that may be perpendicular to front surface 11F, for example. As used herein, describing partially reflecting parallel facets as oblique may describe a plane for each of the partially reflecting parallel facets oriented so that the plane of partially reflecting parallel facets is neither parallel with nor perpendicular with any of the major axes or mutually-parallel major external surfaces describing light-guide optical element 130. In particular, the plane of the exemplary facets 19 and 29 shown in FIG. 4 may be described as partially slanted in reference to at least two or more of the X, Y, and Z axes. Alternatively, the plane of the exemplary facet 29 may also be described as partially rotated, in a positive or negative direction, about to two or more of the axes perpendicular to the corresponding planes XYR, YZR, or XZR. While illustrated together, each of the partially reflecting parallel facets 19 in second aperture expander 16 may be disposed at a different oblique angle from that of partially reflecting parallel facets 29 in first aperture expander 26.

FIG. 5 illustrates a front plan view of an optical device including a light-guide optical element, in accordance with various examples of the present disclosure. Light-guide optical element 130 may include a light cover 36 which may be disposed on a portion of front surface 11F (FIG. 2B) and configured to reduce scattering of the plurality of guided image beams 20 from front surface 11F. Additionally, light cover 36 may also prevent reflections from scenery by reflector 22 into an eye 12 of a user. In this manner, cover 36 may be disposed on a portion of front surface 11F adjacent to reflector 22, where light cover 36 may at least one of reduce scattering of the plurality of guided image beams 20, and reduce impingement of environmental light upon reflector 22 which may improve a user's experience.

FIG. 5 illustrates an example of a first aperture expander 26B with a first plurality of partially reflecting parallel facets 29B and a second aperture expander 16B with a second plurality of partially reflecting parallel facets 16B where either or both first aperture expander 26B and second aperture expander 16B may have a larger area compared with corresponding elements in the example shown in FIG. 3A, which may lead to improved producibility for light- guide optical element 130. As mentioned, in the drawings like reference numbers may indicate identical or functionally similar elements. Hence, first aperture expander 26B may be similar in some ways to first aperture expander 26 illustrated in FIG. 3A, for example. In this example, after leaving reflector 22, the plurality of reflected guided image beams 24 may be directed to a first aperture expander 26B that may be disposed at least partially within light-guide optical element 130 and which extends in full width to an edge of light-guide optical element 130 (e.g., compare with FIG. 3A). The plurality of reflected guided image beams 24 may have a reflected image beam central axis 30 corresponding to a central ray within the plurality of reflected guided image beams 24. First aperture expander 26B may be configured to receive the plurality of reflected guided image beams 24 and expand the plurality of reflected image beams in a first dimension to produce a first plurality of expanded image beams 28B having an expanded image beam central axis 32B that may correspond to a central ray of the plurality of expanded image beams 28B as they leave the first aperture expander 26B. In this manner, a third beam angle 34B between reflected beam central axis 30 and first expanded beam central axis 32B which may be less than 90° but greater than second beam angle 34 (FIG. 3A). The example first aperture expander 26B shown in FIG. 5 has various advantages, including simpler manufacturing and thereby lower costs.

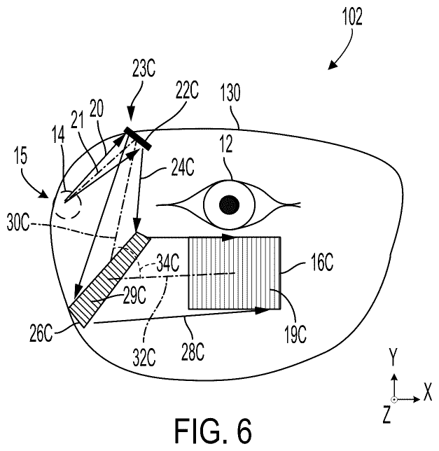

FIG. 6 illustrates a front plan view of an optical device including a light-guide optical element, in accordance with various examples of the present disclosure. The optical device 102 illustrated in FIG. 6 is similar in some ways to the optical device 102 illustrated in FIG. 3A. However, FIG. 6 illustrates a different reflector 22C at a different location 23C as well as a different orientation for a first aperture expander 26C and a different orientation for a second aperture expander 16C, as shown.

Optical device 102 may include light-guide optical element 130 configured to receive a collimated first image beam from an image projector applied to an input portion of input coupler 14 located at first position 15 on or near a peripheral edge of light-guide optical element 130. In this manner, collimated image beam from image projector 126 is injected within a portion of light-guide optical element 130 to produce a plurality of guided image beams 20 due to total internal reflection (TIR) between the parallel front surface 11F and rear surface 11R.

The plurality of guided image beams 20 may continue to propagate within light-guide optical element 130 and be directed to a reflector 22C that may be disposed at or near a peripheral edge of light-guide optical element at a fourth location 23C at or near a peripheral edge of light-guide optical element 130. Hence, reflector 22C may be located close to a peripheral edge of light-guide optical element 130 without overlapping the peripheral edge. As before, this is not considered limiting. In this example, reflector 22C may be a mirror facing an interior portion of light-guide optical element 130 and disposed adjacent to a peripheral edge of light-guide optical element 130 in a location 23C that may be vertically above input coupler 14, for example. Reflector 22C may be formed as a mirrored surface configured to fully reflect the plurality of guided image beams 20. Reflector 22C may be disposed perpendicular to front surface 11F. Alternatively, reflector 22C may be disposed at an angle to the front surface 11F. The plurality of guided image beams 20 may be reflected by reflector 22C as a plurality of reflected guided image beams 24C having a reflected beam central axis 30C that may correspond to a central ray of the plurality of reflected guided image beams 24C as they leave the surface of reflector 22C.

After leaving reflector 22C, the plurality of reflected guided image beams 24C may be directed to a first aperture expander 26C that may be disposed at least partially within light-guide optical element 130. The plurality of reflected guided image beams 24C may have a reflected image beam central axis 30C corresponding to a central ray within the plurality of reflected guided image beams 24. First aperture expander 26C may include a first plurality of partially reflecting parallel facets 29C that may be configured to receive the plurality of reflected guided image beams 24C and expand the plurality of reflected guided image beams 24C in a first dimension to produce a first plurality of expanded image beams 28C having an expanded image beam central axis 32C that may correspond to a central ray of the plurality of expanded image beams 28C as they leave the first aperture expander 26C. The configuration illustrated in FIG. 6 may also provide that a fourth beam angle 34C between reflected beam central axis 30C and expanded image beam central axis 32C may remain large, similar to the configuration illustrated in FIG. 3A, and may provide the same benefits. As with the example of the optical device 102 shown in FIG. 3A, first aperture expander 26C may have a plurality of partially reflecting parallel facets 29C that may be inclined at an angle that may be oblique relative to at least one of the front surface 11F and a transverse plane (e.g., an X-Z plane) perpendicular to front surface 11F, or oblique to both for example.

After leaving first aperture expander 26C, the first plurality of expanded image beams 28C may be directed to a second aperture expander 16C, mentioned briefly above. Second aperture expander 16C may be disposed at least partially within light-guide optical element 130. Aperture expander 16C may include a second plurality of partially reflecting parallel facets 19C configured to receive first plurality of expanded image beams 28C from first aperture expander in a first direction and expand the expanded image beams 28C in a second direction.

First aperture expander 26C may expand reflected guided image beams 24C in a first dimension, and subsequently second aperture expander 16C expands the first plurality of expanded image beams 28C in a second dimension which may exit from rear surface 11R toward the eye 12 of a user. Thus, first aperture expander 26C and second aperture expander 16C may cooperate to expand a version of an input image beam in two dimensions (2D) thus resulting in a two-dimensional expansion of the original aperture of image projector 126, for example.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, the terms up, upper, down, lower, above, below, left, right, forward, rearward, and the like are intended to be understood in the context of the representations described and illustrated above so that a wearable device may have such an orientation in reference to the frame or to various elements as supported by the frame or as illustrated in the drawing figures.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The various embodiments were chosen and described in order to best explain the principles of the invention and the practical application, and to enable others of ordinary skill in the art to understand the invention for various embodiments with various modifications as are suited to the particular use contemplated.

What is claimed is:

1. An optical device comprising:
a light-guide optical element having a front surface and a rear surface that are parallel to each other;
a reflector configured to receive a plurality of guided image beams and reflect a plurality of reflected guided image beams, the plurality of guided image beams and plurality of reflected guided image beam being propagated within the light-guide optical element between the front surface and the rear surface;
a first aperture expander having a first plurality of partially reflecting parallel facets configured to expand the plurality of reflected guided image beams and provide a first plurality of expanded image beams; and
a second aperture expander having a second plurality of partially reflecting parallel facets configured to expand the first plurality of expanded image beams and provide a second plurality of expanded image beams.

2. The optical device of claim 1,
wherein the plurality of guided image beams have a guided image beam central axis,
wherein the plurality of reflected guided image beams have a reflected guided image beam central axis, and
wherein an angle between the guided image beam central axis and the reflected guided image beam central axis is greater than 90°.

3. The optical device of claim 1, wherein the reflector is at least one of:
disposed perpendicular to the front surface; and
disposed on a peripheral edge of light-guide optical element,
the reflector being configured to fully reflect the received plurality of guided image beams.

4. The optical device of claim 1, further comprising:
an input coupler configured to receive a collimated first image beam from an image projector and output the plurality of guided image beams, the plurality of guided image beams being propagated within the light-guide optical element between the front surface and the rear surface,
wherein the input coupler is disposed one of adjacent to one of the front surface and the rear surface and at least partially embedded within the light-guide optical element, and
wherein the input coupler is one of a prism, a diffractive element, a reflective element, or a holographic element.

5. The optical device of claim 4,
wherein the reflector is a mirror facing an interior portion of the light-guide optical element and disposed adjacent to a peripheral edge of the light-guide optical element in a location that is one of:
vertically below the input coupler, and
vertically above the input coupler.

6. The optical device of claim 1,
wherein the first plurality of partially reflecting parallel facets are inclined at a first angle that is one of oblique relative to at least one of the front surface and a transverse plane perpendicular to the front surface; and
wherein the second plurality of partially reflecting parallel facets are inclined at a second angle that is one of oblique relative to at least one of the front surface and a transverse plane perpendicular to the front surface.

7. The optical device of claim 6, wherein at least one of the first plurality of partially reflecting parallel facets and the second plurality of partially reflecting parallel facets includes an angularly selective coating.

8. The optical device of claim 1,
wherein an upper portion of the light-guide optical element includes an optically clear line-of-sight region, and
wherein the second aperture expander is disposed vertically below the line-of-sight region.

9. The optical device of claim 1,
wherein the first aperture expander is configured to expand the plurality of reflected guided image beams in a first dimension, the second aperture expander is configured to expand the first plurality of expanded image beams in a second dimension, and the first dimension and the second dimension are substantially orthogonal to each other.

10. The optical device of claim 1, further comprising:
a light cover disposed on a portion the front surface adjacent to the reflector, the light cover configured to at least one of:
reduce scattering of the plurality of guided image beams, and
reduce impingement of environmental light upon the reflector.

11. The optical device of claim 1, wherein the second plurality of expanded image beams are configured to exit from the rear surface.

12. An optical system comprising:
a light-guide optical element having a front surface and a rear surface that are parallel to each other;
an image projector configured to produce a collimated first image beam based on a digital image, wherein the collimated first image beam is collimated to infinity;
an input coupler configured to receive the collimated first image beam and output a plurality of guided image beams within the light-guide optical element, the plurality of guided image beams being propagated between the front surface and the rear surface;
a reflector configured to receive a plurality of guided image beams and reflect a plurality of reflected guided image beams, the plurality of guided image beams being propagated within the light-guide optical element between the front surface and the rear surface;
a first aperture expander having a first plurality of partially reflecting parallel facets configured to expand the plurality of reflected image beams in a first dimension and provide a first plurality of expanded image beams; and
a second aperture expander having a second plurality of partially reflecting parallel facets configured to expand the first plurality of expanded image beams in a second dimension and provide a second plurality of expanded image beams configured to exit from the rear surface.

13. The optical system of claim 12,
wherein the input coupler is disposed one of adjacent to one of the front surface and the rear surface and at least partially embedded within the light-guide optical element, and
wherein the input coupler is one of a prism, a diffractive element, a reflective element, or a holographic element.

14. The optical system of claim 12, further comprising:
a frame configured to support at least a portion of the light-guide optical element and image projector, the frame being configured to be worn on a portion of a head of a user adjacent to an eye of the user;
an optical engine configured to receive the digital image and operate the image projector; and
a controller configured to operate the optical engine and projector.

15. The optical system of claim 12,
wherein the plurality of guided image beams have a guided image beam central axis,
wherein the plurality of reflected guided image beams have a reflected guided image beam central axis, and
wherein an angle between the guided image beam central axis and the reflected guided image beam central axis is greater than 90°.

16. The optical system of claim 12,
wherein the reflector is a mirror facing an interior portion of the light-guide optical element and disposed adjacent to a peripheral edge of the light-guide optical element that is one of:
vertically below the input coupler, and
vertically above the input coupler,
the reflector being configured to fully reflect the received plurality of guided image beams.

17. The optical system of claim 12,
wherein the first aperture expander includes a plurality of partially reflecting parallel facets that are inclined at an angle that is one of:
oblique relative to at least one of the front surface and a transverse plane perpendicular to the front surface, and
perpendicular to the front surface.

18. The optical system of claim 17, wherein at least one of the first plurality of partially reflecting parallel facets and the second plurality of partially reflecting parallel facets includes an angularly selective coating.

19. The optical system of claim 12,
wherein an upper portion of the light-guide optical element includes an optically clear line-of-sight region, and
wherein the second aperture expander is disposed vertically below the line-of-sight region.

20. The optical system of claim 12, further comprising:
a partial plane reflector disposed within the light-guide optical element parallel with the front surface; and
a light cover disposed on a portion the front surface adjacent to the reflector, the light cover configured to at least one of:
reduce scattering of the plurality of guided image beams, and
reduce impingement of environmental light upon the reflector.
